(19) United States
(12) Patent Application Publication
(10) Pub. No.: US 2017/0154411 A1
(43) Pub. Date: Jun. 1, 2017

(54) METHOD AND ELECTRONIC APPARATUS FOR ADJUSTING IMAGE QUALITY OF VIDEO

(71) Applicants: Le Holdings (Beijing) Co., Ltd., Beijing (CN); LeCloud Computing Co., Ltd., Beijing (CN)

(72) Inventors: Yang Liu, Beijing (CN); Wei Wei, Beijing (CN); Maosheng Bai, Beijing (CN)

(21) Appl. No.: 15/246,854

(22) Filed: Aug. 25, 2016

Related U.S. Application Data
(63) Continuation of application No. PCT/CN2016/088650, filed on Jul. 5, 2016.

(30) Foreign Application Priority Data
Dec. 1, 2015 (CN) 201510867210.5

(51) Int. Cl. G06T 5/00; G06T 5/40; H04N 9/64

(52) U.S. Cl. CPC G06T 5/009; H04N 9/646; G06T 5/40; G06T 2207/10016; G06T 2207/10024; G06T 2207/20208; G06T 2207/20072

(57) ABSTRACT

Disclosed is a method and an electronic apparatus for adjusting image quality of video, which includes: acquiring a luminance histogram of a current video frame according to a grayscale image of the current video frame; acquiring a number of a plurality of pixels on left half and right half of the luminance histogram and an trisected number of a plurality of pixels of the luminance histogram according to the luminance histogram of a current video frame; adjusting a luminance of the current video frame according to the number of the plurality of pixels on left half and right half of the luminance histogram; and adjusting a contrast ratio of the current video frame according to the trisected number of the plurality of pixels of the luminance histogram. Therefore, the experiences of watching the video become better.

### CROSS REFERENCE TO RELATED APPLICATIONS

This application is a continuation of International Application No. PCT/CN2016/088650, filed on Jul. 5, 2016, which is based upon and claims priority to Chinese Patent Application No. 201510867210.5, titled as “method and device for adjusting image quality of video” and filed on Dec. 1, 2015, the entire contents of which are incorporated herein by reference.

### TECHNICAL FIELD

The present invention relates to the field of videos of an interconnection internet, more specifically to a method and an electronic apparatus for adjusting image quality of a video.

### BACKGROUND

When the multimedia technology and the interconnection network technology develop rapidly, more and more videos are spread via internet. Some videos have problems of poor video qualities during production processes or transmission processes such as low contrast ratios or improper luminance so that experiences of watching the videos are affected.

### SUMMARY

In view of this, the present application provides a method and an electronic apparatus for adjusting image quality of video.

In one embodiment of the present invention, the method for adjusting image quality of video includes following steps. acquiring a luminance histogram of a current video frame according to a grayscale image of the video frame; acquiring a number of a plurality of pixels on left half of the luminance histogram, a number of a plurality of pixels on right half of the luminance histogram and a trisected number of a plurality of pixels of the luminance histogram, according to the luminance histogram of a current video frame; adjusting a luminance of the current video frame according to the number of the plurality of pixels on left half of the luminance histogram and the number of the plurality of pixels on right half of the luminance histogram; adjusting a contrast ratio of the current video frame according to the trisected number of the plurality of pixels of the luminance histogram.

wherein the acquiring the number of the plurality of pixels on left half of the luminance histogram and the number of the plurality of pixels on right half of the luminance histogram comprises:

calculating the number of the plurality of pixels on left half of the luminance histogram and the number of the plurality of pixels on right half of the luminance histogram through a histogram function according to the luminance histogram of the current video frame;

wherein formulas for calculating the number of the plurality of pixels on left half of the luminance histogram and the number of the plurality of pixels on right half of the luminance histogram are:

$$\{ \begin{matrix}{S}_{l} = {\sum }_{i = 0}^{127} hist [ i ] \\ {S}_{r} = {\sum }_{i = 128}^{255} hist [ i ]\end{matrix} ;$$

wherein hist is the histogram function, i is a grayscale value of the luminance histogram, Sₗ represents the number of the plurality of pixels on left half of the luminance histogram, and Sᵣ represents the number of the plurality of pixels on right half of the luminance histogram.

wherein the acquiring the trisected number of the plurality of pixels of the luminance histogram comprises:

calculating the trisected number of the plurality of pixels of the luminance histogram through a histogram function according to the luminance histogram of the current video frame, wherein formulas for calculating the trisected number of the plurality of pixels of the luminance histogram are:

$$\{ \begin{matrix}{C}_{l} = {\sum }_{i = 0}^{84} hist [ i ] \\ {C}_{m} = {\sum }_{i = 85}^{170} hist [ i ] \\ {C}_{r} = {\sum }_{i = 171}^{255} hist [ i ]\end{matrix}$$

wherein i is a grayscale value of the luminance histogram, and Cₗ, Cₘ and Cᵣ respectively represents the trisected number of the plurality of pixels of the luminance histogram.

wherein the adjusting the luminance of the current video frame according to the number of the plurality of pixels on left half of the luminance histogram and the number of the plurality of pixels on right half of the luminance histogram comprises:

calculating a luminance distribution ratio of the luminance histogram according to the number of the plurality of pixels on left half of the luminance histogram and the number of the plurality of pixels on right half of the luminance histogram, the luminance distribution ratio is labeled as Rᵢ, and an formula for calculating the luminance distribution ratio is:

$${R}_{i} = \frac{{S}_{l}}{{S}_{r}} ;$$

increasing the luminance of the current video frame by y=x^{0.5} if Ri is greater than a first threshold; and

decreasing the luminance of the current video frame by y=x² if Ri is less than a second threshold;

wherein x represents an input pixel value before adjusting the luminance of the current video frame, y represents an output pixel value after adjusting the luminance of the current video frame, the input pixel value is normalized to be in a range from 0 to 1, and the output pixel value is conversely normalized to be within an original range from 0 to 255 from the range from 0 to 1.

wherein the adjusting the contrast ratio of the current video frame according to the trisected number of the plurality of pixels of the luminance histogram comprises:

adjusting the contrast ratio of the current video frame through an formula

$$y = 1 + \frac{2 ( x - 1 )}{1 + {( x - 1 )}^{2}}$$

if the trisected number of the plurality of pixels of the luminance histogram Cₗ, Cₘ and Cᵣ satisfies an formula Cₘ>Cₗ+Cᵣ;

wherein x represents an input pixel value before adjusting the contrast ratio of the current video frame, y represents an output pixel value after adjusting the contrast ratio of the current video frame, the input pixel value is normalized to be within a range from 0 to 2, and the output pixel value is conversely normalized to be within an original range from 0 to 255 from the range from 0 to 2.

An embodiment of the present application provides a non-volatile computer storage medium storing computer-executable instructions, and the computer-executable instructions can carry out the method for adjusting video quality above in any one of the embodiments.

An electronic apparatus for adjusting image quality of video is further disclosed in the present invention. The electronic apparatus includes a memory and a processor, wherein:

The memory is configured to store one or a plurality of instructions provided to the processor for executions.
The processor is configured to acquire the luminance histogram of the current video frame according to the grayscale image of the current video frame. The processor is configured to acquire a number of a plurality of pixels on left half of the luminance histogram and a number of a plurality of pixels on right half of the luminance histogram and a trisected number of a plurality of pixels of the luminance histogram according to the luminance histogram of the video frame. The processor is configured to adjust the luminance of the video frame according to the number of the plurality of pixels on left half of the luminance histogram and the number of the plurality of pixels on right half of the luminance histogram. The processor is configured to adjust the contrast ratio of the video frame according to the trisected number of the plurality of pixels of the luminance histogram.

Specifically, the processor is configured to calculate the number of the plurality of pixels on left half of the luminance histogram and the number of the plurality of pixels on right half of the luminance histogram through a histogram function according to the luminance histogram of the video frame, and formulas for calculating the number of the plurality of pixels on left half of the luminance histogram and the number of the plurality of pixels on right half of the luminance histogram are expressed as:

$$\{ \begin{matrix}{S}_{l} = {\sum }_{i = 0}^{127} hist [ i ] \\ {S}_{r} = {\sum }_{i = 128}^{255} hist [ i ]\end{matrix}$$

In the above formulas, hist is the histogram function, i is a grayscale value of the luminance histogram, Sₗ represents the number of the plurality of pixels on left half of the luminance histogram, and Sᵣ represents the number of the plurality of pixels on right half of the luminance histogram.

Specifically, the processor is configured to calculate the trisected number of the plurality of pixels of the luminance histogram through a histogram function according to the luminance histogram of the video frame, and formulas for calculating the trisected number of the plurality of pixels of the luminance histogram are expressed as:

$$\{ \begin{matrix}{C}_{l} = {\sum }_{i = 0}^{84} hist [ i ] \\ {C}_{m} = {\sum }_{i = 85}^{170} hist [ i ] \\ {C}_{r} = {\sum }_{i = 171}^{255} hist [ i ]\end{matrix}$$

In the above formula, i is a grayscale value of the luminance histogram, and Cₗ, Cₘ and Cᵣ respectively represents the trisected number of the plurality of pixels of the luminance histogram.

Specifically, the processor is configured calculate a luminance distribution ratio of the luminance histogram, the luminance distribution ratio of the luminance histogram is labeled as Ri, and an formula for calculating the luminance distribution ratio is expressed as:

$${R}_{i} = \frac{{S}_{l}}{{S}_{r}}$$

If Rᵢ is greater than a first threshold, the luminance of the video frame is increased by y=x^{0.5}.
If Rᵢ is less than a second threshold, the luminance of the video frame is decreased by y=x².
In the above formulas, x represents an input pixel value before adjusting the luminance of the video frame. y represents an output pixel value after adjusting the luminance of the video frame. the input pixel value is within a range from 0 to 1, and the output pixel value is conversely normalized to be within an original range from 0 to 255 from the range from 0 to 1.

Specifically, the processor is configured to adjust the contrast ratio of the video frame through a formula

$$y = 1 + \frac{2 ( x - 1 )}{1 + {( x - 1 )}^{2}}$$

if the trisected number of the plurality of pixels of the luminance histogram Cₗ, Cₘ and Cᵣ satisfies a formula Cₘ>Cₗ+Cᵣ.
In the above formula, x represents an input pixel value before adjusting the contrast ratio of the video frame. y represents an output pixel value after adjusting the contrast ratio of the video frame. The input pixel value is normalized to be within a range from 0 to 2, and the output pixel value is conversely normalized to be within an original range from 0 to 255 from the range from 0 to 2.

### BRIEF DESCRIPTION OF THE DRAWINGS

One or more embodiments are illustrated by way of example, and not by limitation, in the figures of the accompanying drawings, wherein elements having the same reference numeral designations represent like elements throughout. The drawings are not to scale, unless otherwise disclosed.

FIG. 1 is a flow chart of method for adjusting image quality of video in one embodiment.

FIG. 2 is an image of a function of formula 3 in one embodiment.

FIG. 3 is an image of a function of formula 4 in one embodiment.

FIG. 4 is an image of a function of formula 7 in one embodiment.

FIG. 5 is a schematic diagram of an adjusting device for image quality of video in one embodiment.

FIG. 6 is a schematic diagram of an electronic apparatus for adjusting image quality of video in one embodiment.

### DETAILED DESCRIPTION

The present invention is illustrated by the following figures of accompanying drawings and embodiments whereby the implementation process of the technology of the present invention for solving technical problems and achieving technical efficiency would be fully understood and implemented accordingly.

In a typical configuration, computing equipments include one or a plurality of processors, input/output interfaces and memories.

A memory may include a volatile memory of a computer readable medium, a random access memory (RAM) of a computer readable medium and/or a non-volatile memory of a computer readable medium such as a read-only memory (ROM) or a flash random access memory (flash RAM). The memory is one example of a computer readable medium.

A computer readable medium includes volatile memories or non-volatile memories. A mobile or non-mobile medium could execute information storages by any ways or technologies. The information could be a computer readable instruction, a data structure, a program module or other data. A storage medium of a computer includes but not limited to a phase-change memory (PRAM), a static random-access memory (SRAM), a dynamic random access memory (DRAM), other type of random access memory (RAM), a read-only memory (ROM), an electrically-erasable programmable read-only memory (EEPROM), a flash memory or other memory technology, a compact disc read-only memory (CD-ROM), a digital versatile disc (DVD) or other optical storage, a cassette magnetic tape, a magnetic tape data storage, other magnetic storage or other non-transmission medium used to store information which can be accessed by computing equipment. According to the present invention, the computer readable medium does not include a non-transitory media such as a data signal and a signal carrier.

As shown in the specification and claim, some terms are used to indicate some particular components. Persons having ordinary skills in the art could realize that different terms may be used to indicate one component. In the specification and claim, components will be distinguished according to their functions instead of their names. As mentioned in the specification and claim, “include” is an open term. Therefore “include” should be explained as “include but not limit”. “Approximately” means an acceptable tolerance scope. Persons having ordinary skills in the art are able to solve the said technical problems within the tolerance scope so that the technical effects could be reached. In addition to that, the term “couple” includes any direct and indirect electrical connections. Therefore, if the present disclosure indicates that a first device is couple to a second device, and then it is indicated that the first device is directly and electrically connected to the second device, or the first device is indirectly connected to the second device through other devices or ways. The descriptions in the following paragraphs are used to illustrate some embodiments of the present invention. However, the descriptions are just for illustrating the general principles of the present invention and not for limiting the present invention. The scope of the present invention is defined according to what is claimed.

Note that the technical terms “include”, “comprise” or other variants are no-exclusive so that products or systems including a series of elements not only include the series of elements mentioned but also include elements other than the series of elements mentioned or inherent elements of the products or systems. Without limitations, elements defined by the sentence “include one . . . ” shall not exclusive of the products including the elements or the systems having other same elements.

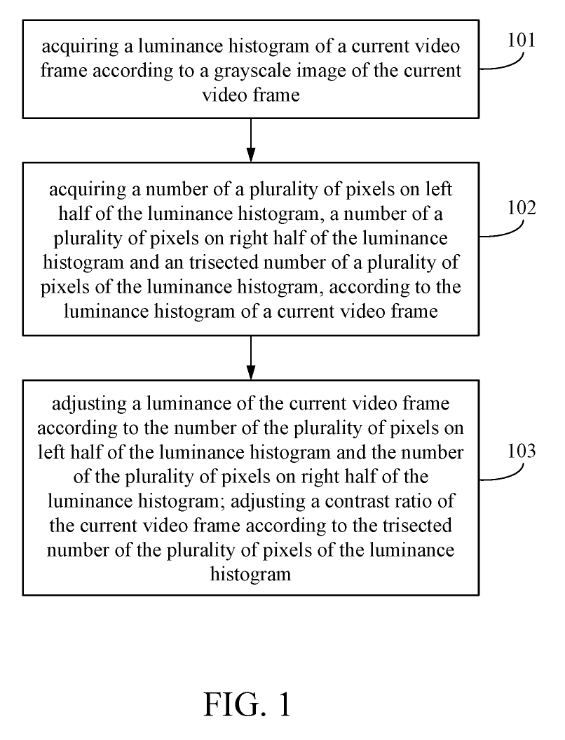

FIG. 1 is a flow chart of method for adjusting image quality of video in one embodiment. As shown in FIG. 1, in step 101, a luminance histogram of current video frame is acquired according to a grayscale image of a current video frame. The current video frame could be transformed into the grayscale image through the following methods:

Gray=R*0.3+G*0.59+B*0.11 Method of calculating floating-points:

Gray=(R*30+G*59+B*11)/100 Method of integers:

Gray=(R*76+G*151+B*28)>>8 Method of displacement:

Gray=(R+G+B)/3 Method of calculating average:

Gray=G Method of selecting green only:

After Gray is obtained through one of the above methods, original R, G, B of RGB (R, G, B) is replaced with Gray so that new RGB (Gray, Gray, Gray) is formed. The RGB (Gray, Gray, Gray) represents the grayscale image.

Based on the grayscale image of the current video frame, for example, the luminance histogram of the grayscale image could be acquired using Photoshop program. The methods of acquiring the histogram of the present invention are not limited to the method above.

In step 102, a number of a plurality of pixels on left half of the luminance histogram and a number of a plurality of pixels on right half of the luminance histogram and a trisected number of a plurality of pixels of the luminance histogram are acquired according to the luminance histogram of the current video frame.

Alternatively, in step 102, the acquiring the number of the plurality of pixels on left half of the luminance histogram and the number of the plurality of pixels on right half of the luminance histogram includes the following steps:

The number of the plurality of pixels on left half of the luminance histogram and the number of the plurality of pixels on right half of the luminance histogram are calculated through a histogram function according to the luminance histogram of the current video frame. The formulas for calculating the number of the plurality of pixels on left half of the luminance histogram and the number of the plurality of pixels on right half of the luminance histogram are expressed as:

$$\{ \begin{matrix}{S}_{l} = {\sum }_{i = 0}^{127} hist [ i ] \\ {S}_{r} = {\sum }_{i = 128}^{255} hist [ i ]\end{matrix}$$

In the formulas, hist is the histogram function. i is a grayscale value of the luminance histogram. Sₗ represents the number of the plurality of pixels on left half of the luminance histogram. Sᵣ represents the number of the plurality of pixels on right half of the luminance histogram.

Alternatively, in step 102, the acquiring the trisected number of the plurality of pixels of the luminance histogram includes the following steps:

The trisected number of the plurality of pixels of the luminance histogram is calculated through the histogram function according to the luminance histogram of the current video frame. The formulas for calculating the trisected number of the plurality of pixels of the luminance histogram are expressed as:

$$\{ \begin{matrix}{C}_{l} = {\sum }_{i = 0}^{84} hist [ i ] \\ {C}_{m} = {\sum }_{i = 85}^{170} hist [ i ] \\ {C}_{r} = {\sum }_{i = 171}^{255} hist [ i ]\end{matrix}$$

In the above formulas, i is a grayscale value of the luminance histogram. Cₗ, Cₘ and Cᵣ respectively represents the trisected number of the plurality of pixels of the luminance histogram.

In step 103, the luminance of the current video frame is adjusted according to the number of the plurality of pixels on left half of the luminance histogram and the number of the plurality of pixels on right half of the luminance histogram. The contrast ratio of the current video frame is adjusted according to the trisected number of the plurality of pixels of the luminance histogram.

Alternatively, in step 103, the adjusting the luminance of the current video frame according to the number of the plurality of pixels on left half of the luminance histogram and the number of the plurality of pixels on right half of the luminance histogram includes the following steps:

The luminance distribution ratio of the luminance histogram is calculated according to the number of the plurality of pixels on left half of the luminance histogram and the number of the plurality of pixels on right half of the luminance histogram. The luminance distribution ratio is labeled as Rᵢ. The formula for calculating the luminance distribution ratio is expressed as:

$${R}_{i} = \frac{{S}_{l}}{{S}_{r}}$$

If Rᵢ is greater than the first threshold, the luminance of the current video frame is increased through y=x^{0.5}. The first threshold includes 2.5.
If Ri is less than the second threshold, the luminance of the current video frame is decreased through y=x². The second threshold includes 0.4.
In the above formulas, x represents the input pixel value before adjusting the luminance of the current video frame, and y represents the output pixel value after adjusting the luminance of the current video frame. The input pixel value is normalized to be within the range from 0 to 1, and the output pixel value is conversely normalized to be within the original range from 0 to 255 from the range from 0 to 1.

Alternatively, in step 103, the adjusting the contrast ratio of the current video frame according to the trisected number of the plurality of pixels of the luminance histogram includes the following steps:

If the trisected number of the plurality of pixels of the luminance histogram Cₗ, Cₘ and Cᵣ satisfies the formula Cₘ>Cₗ+Cᵣ, the contrast ratio of the current video frame is adjusted through an formula expressed as:

$$y = 1 + \frac{2 ( x - 1 )}{1 + {( x - 1 )}^{2}}$$

In the above formula, x represents the input pixel value before adjusting the luminance of the current video frame, and y represents the output pixel value after adjusting the luminance of the current video frame. The input pixel value is normalized to be within the range from 0 to 2, and the output pixel value is conversely normalized to be within the original range from 0 to 255 from the range from 0 to 2.

In the embodiment of the present invention, the number of the plurality of pixels on left half of the luminance histogram and the number of the plurality of pixels on right half of the luminance histogram and the trisected number of the plurality of pixels of the luminance histogram are acquired according to the luminance histogram of the current video frame. The luminance of the current video frame is adjusted according to the number of the plurality of pixels on left half of the luminance histogram and the number of the plurality of pixels on right half of the luminance histogram. The contrast ratio of the current video frame is adjusted according to the trisected number of the plurality of pixels of the luminance histogram. Therefore, the luminance and the contrast ratio of the video could be automatically adjusted according to the image quality of the input video so that the experiences of watching the video become better.

The present invention is illustrated in detail through the specific implementations below.

In the present invention, the video is processed frame by frame. First of all, each frame of the video will be turned into a grayscale image. Then a luminance histogram of the grayscale image will be calculated and stored in the a histogram function hist[256], wherein 256 represents the total number of pixels of the grayscale image.

The number of the plurality of pixels on left half of the histogram and the number of the plurality of pixels on right half of the histogram is respectively calculated and labeled as Sₗ and Sᵣ according to the formula (1) below. Sₗ represents the number of the plurality of pixels on left half of the luminance histogram, and Sᵣ represents the number of the plurality of pixels on right half of the luminance histogram.

$$\{ \begin{matrix}{S}_{l} = {\sum }_{i = 0}^{127} hist [ i ] \\ {S}_{r} = {\sum }_{i = 128}^{255} hist [ i ]\end{matrix} \qquad ( 1 )$$

The luminance distribution ratio of the histogram is calculated and labeled as Rᵢ according to the formula (2).

$${R}_{i} = \frac{{S}_{l}}{{S}_{r}} \qquad ( 2 )$$

If Rᵢ is greater than 2.5, it means the luminance of the video is too low. Then the luminance of the video would be increased using the formula (3).

y=x^{0.5} (3)

If Rᵢ is less than 0.4, it means the luminance of the video is too high. Then the luminance of the video would be decreased using the formula (4).

y=x² (4)

Note that each channel of a frame is transformed by the formula (3) and the formula (4) during the process of adjustment. In the above formulas, x represents the input pixel value before adjusting the luminance of the video, and y represents the output pixel value after adjusting the luminance of the video. First of all, the input pixel value is normalized to be within the range from 0 to 1. Then the output pixel value will be conversely normalized to be within the original range from 0 to 255 from the range from 0 to 1.

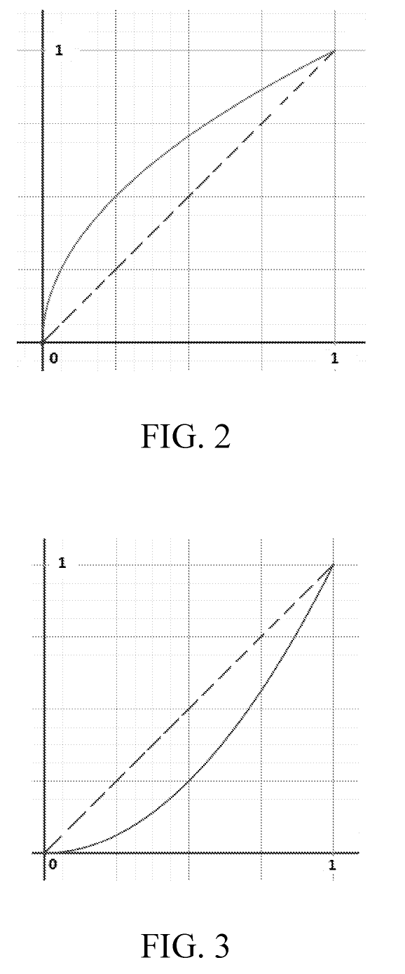

The image of the formula (3) is shown in FIG. 2, and the dotted line represents y=x. The image of the formula (4) is shown in FIG. 3, and the dotted line represents y=x.

The trisected number of the plurality of pixels of the histogram hist is calculated according to the formula (5) and respectively labeled as Cₗ, Cₘ and Cᵣ.

$$\{ \begin{matrix}{C}_{l} = {\sum }_{i = 0}^{84} hist [ i ] \\ {C}_{m} = {\sum }_{i = 85}^{170} hist [ i ] \\ {C}_{r} = {\sum }_{i = 171}^{255} hist [ i ]\end{matrix} \qquad ( 5 )$$

If Cₗ, Cₘ and Cᵣ satisfy the formula (6), then the contrast ratio of the current video frame is adjusted using the formula (7).

$$\begin{matrix}{C}_{m} > {C}_{l} + {C}_{r} & ( 6 ) \\ y = 1 + \frac{2 ( x - 1 )}{1 + {( x - 1 )}^{2}} & ( 7 )\end{matrix}$$

Each channel of a frame is transformed by the formula (7) during the process of adjustment. In the formula, x represents the input pixel value before adjusting the contrast ratio of the current video frame, and y represents the input pixel value after adjusting the contrast ratio of the current video frame. First of all, the input pixel value is normalized to be within the range from 0 to 2, and the output pixel value is conversely normalized to be within the original range from 0 to 255 from the range from 0 to 2.

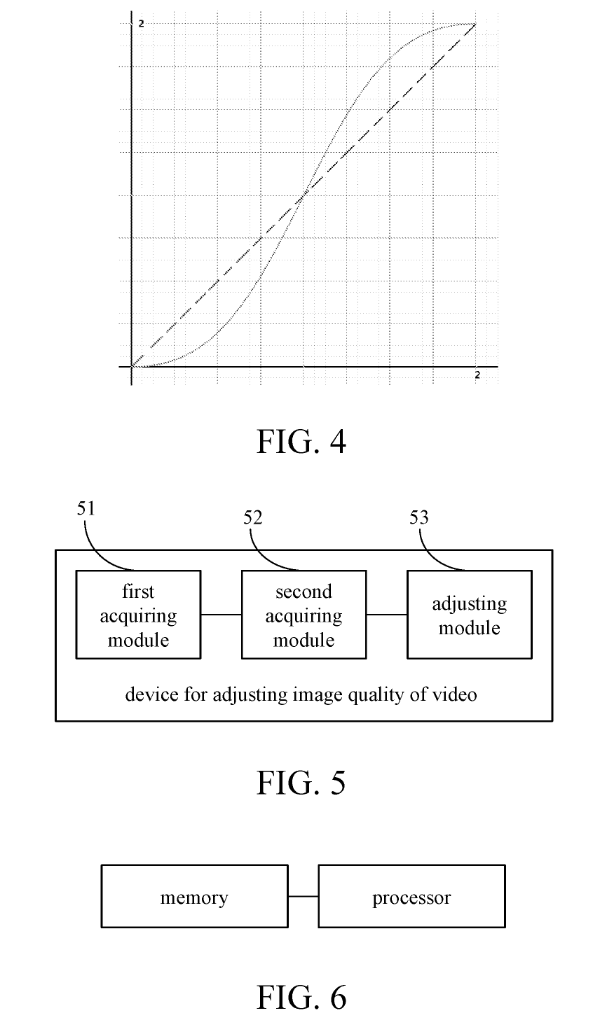

The image of the formula (7) is shown in FIG. 4, and the dotted line represents y=x.

FIG. 5 is a schematic diagram of a device for adjusting image quality of video in one embodiment. As shown in FIG. 5, a first acquiring module 51 is configured to acquire the luminance histogram of the current video frame according to the grayscale image of the current video frame. The second acquiring module 52 is configured to acquire a number of a plurality of pixels on left half of the luminance histogram and a number of a plurality of pixels on right half of the luminance histogram and a trisected number of a plurality of pixels of the luminance histogram according to the luminance histogram of the video frame.

An adjusting module 53 is configured to adjust the luminance of the video frame according to the number of the plurality of pixels on left half of the luminance histogram and the number of the plurality of pixels on right half of the luminance histogram acquired by the second acquiring module, and adjust the contrast ratio of the video frame according to the trisected number of the plurality of pixels of the luminance histogram.

Specifically, the second acquiring module 52 is configured to calculate the number of the plurality of pixels on left half of the luminance histogram and the number of the plurality of pixels on right half of the luminance histogram through a histogram function according to the luminance histogram of the video frame, and formulas for calculating the number of the plurality of pixels on left half of the luminance histogram and the number of the plurality of pixels on right half of the luminance histogram are expressed as:

$$\{ \begin{matrix}{S}_{l} = {\sum }_{i = 0}^{127} hist [ i ] \\ {S}_{r} = {\sum }_{i = 128}^{255} hist [ i ]\end{matrix}$$

In the above formula, hist is the histogram function, and i is a grayscale value of the luminance histogram. Sₗ represents the number of the plurality of pixels on left half of the luminance histogram, and Sᵣ represents the number of the plurality of pixels on right half of the luminance histogram.

Specifically, the second acquiring module 52 is further configured to calculate the trisected number of the plurality of pixels of the luminance histogram through a histogram function according to the luminance histogram of the video frame, and formulas for calculating the trisected number of the plurality of pixels of the luminance histogram are expressed as:

$$\{ \begin{matrix}{C}_{l} = {\sum }_{i = 0}^{84} hist [ i ] \\ {C}_{m} = {\sum }_{i = 85}^{170} hist [ i ] \\ {C}_{r} = {\sum }_{i = 171}^{255} hist [ i ]\end{matrix}$$

In the above formula, i is a grayscale value of the luminance histogram, and Cₗ, Cₘ and Cᵣ respectively represents the trisected number of the plurality of pixels of the luminance histogram.

Specifically, the adjusting module 53 is configured to calculate a luminance distribution ratio of the luminance histogram, the luminance distribution ratio of the luminance histogram is labeled as Ri, and an formula for calculating the luminance distribution ratio is:

$${R}_{i} = \frac{{S}_{l}}{{S}_{r}}$$

If Ri is greater than a first threshold, the luminance of the video frame is increased by y=x^{0.5}, and the first threshold includes 2.5.
If Ri is less than a second threshold, the luminance of the video frame is decreased by y=x², and the second threshold includes 0.4.
In the above formula, x represents an input pixel value before adjusting the luminance of the video frame, y represents an output pixel value after adjusting the luminance of the video frame, the input pixel value is normalized to be within a range from 0 to 1, and the output pixel value is conversely normalized to be within an original range from 0 to 255 from the range from 0 to 1.

Specifically, the adjusting module 53 is configured to adjust the contrast ratio of the video frame through a formula

$$y = 1 + \frac{2 ( x - 1 )}{1 + {( x - 1 )}^{2}}$$

if the trisected number of the plurality of pixels of the luminance histogram Cₗ, Cₘ and Cᵣ satisfies an formula Cₘ>Cₗ+Cᵣ.
In the above formula, x represents an input pixel value before adjusting the contrast ratio of the video frame, y represents an output pixel value after adjusting the contrast ratio of the video frame, the input pixel value is normalized to be within a range from 0 to 2, and the output pixel value is conversely normalized to be within a original range from 0 to 255 from the range from 0 to 2.

The adjusting device of FIG. 5 could implement the method of embodiments shown in FIG. 1 and the fundamental of implementing the adjusting device and the effects of the technology of the adjusting device are not repeated here.

FIG. 6 is a schematic diagram of an electronic apparatus for adjusting image quality of video in one embodiment. As shown in FIG. 6, the electronic apparatus includes a memory and a processor. The memory is configured to store one or a plurality of instructions provided to the processor for executions.

The processor is configured to acquire the luminance histogram of the current video frame according to the grayscale image of the current video frame. The processor is configured to acquire a number of a plurality of pixels on left half of the luminance histogram and a number of a plurality of pixels on right half of the luminance histogram and a trisected number of a plurality of pixels of the luminance histogram according to the luminance histogram of the video frame. The processor is configured to adjust the luminance of the video frame according to the number of the plurality of pixels on left half of the luminance histogram and the number of the plurality of pixels on right half of the luminance histogram. The processor is configured to adjust the contrast ratio of the video frame according to the trisected number of the plurality of pixels of the luminance histogram.

Specifically, the processor is configured to calculate the number of the plurality of pixels on left half of the luminance histogram and the number of the plurality of pixels on right half of the luminance histogram through a histogram function according to the luminance histogram of the video frame, and formulas for calculating the number of the plurality of pixels on left half of the luminance histogram and the number of the plurality of pixels on right half of the luminance histogram are expressed as:

$$\{ \begin{matrix}{S}_{l} = {\sum }_{i = 0}^{127} hist [ i ] \\ {S}_{r} = {\sum }_{i = 128}^{255} hist [ i ]\end{matrix}$$

In the above formulas, hist is the histogram function, i is a grayscale value of the luminance histogram, Sₗ represents the number of the plurality of pixels on left half of the luminance histogram, and Sᵣ represents the number of the plurality of pixels on right half of the luminance histogram.

Specifically, the processor is configured to calculate the trisected number of the plurality of pixels of the luminance histogram through a histogram function according to the luminance histogram of the video frame, and formulas for calculating the trisected number of the plurality of pixels of the luminance histogram are expressed as:

$$\{ \begin{matrix}{C}_{l} = {\sum }_{i = 0}^{84} hist [ i ] \\ {C}_{m} = {\sum }_{i = 85}^{170} hist [ i ] \\ {C}_{r} = {\sum }_{i = 171}^{255} hist [ i ]\end{matrix}$$

In the above formula, i is a grayscale value of the luminance histogram, and Cₗ, Cₘ and Cᵣ respectively represents the trisected number of the plurality of pixels of the luminance histogram.

Specifically, the processor is configured calculate a luminance distribution ratio of the luminance histogram, the luminance distribution ratio of the luminance histogram is labeled as Ri, and an formula for calculating the luminance distribution ratio is expressed as:

$${R}_{i} = \frac{{S}_{l}}{{S}_{r}}$$

If Rᵢ is greater than a first threshold, the luminance of the video frame is increased by y=x^{0.5}.
If Rᵢ is less than a second threshold, the luminance of the video frame is decreased by y=x².
In the above formulas, x represents an input pixel value before adjusting the luminance of the video frame. y represents an output pixel value after adjusting the luminance of the video frame. the input pixel value is within a range from 0 to 1, and the output pixel value is conversely normalized to be within an original range from 0 to 255 from the range from 0 to 1.

Specifically, the processor is configured to adjust the contrast ratio of the video frame through a formula

$$y = 1 + \frac{2 ( x - 1 )}{1 + {( x - 1 )}^{2}}$$

if the trisected number of the plurality of pixels of the luminance histogram Cₗ, Cₘ and Cᵣ satisfies a formula Cₘ>Cₗ+Cᵣ.
In the above formula, x represents an input pixel value before adjusting the contrast ratio of the video frame. y represents an output pixel value after adjusting the contrast ratio of the video frame. The input pixel value is normalized to be within a range from 0 to 2, and the output pixel value is conversely normalized to be within an original range from 0 to 255 from the range from 0 to 2.

The electronic apparatus for performing the method for adjusting image quality of video can further includes: an input device and an output device.

The processor, the memory, the input device and the output device could be connected to each other via a bus or other members for connection.

The memory is one kind of non-volatile computer-readable storage mediums applicable to store non-volatile software programs, non-volatile computer-executable programs and modules; for example, the program instructions and the function modules (the first acquiring module 51, the second acquiring module 52 and the adjusting module 53 in FIG. 5) corresponding to the method for adjusting image quality of video in the embodiments are respectively a computer-executable program and a computer-executable module. The processor executes function applications and data processing of the server by running the non-volatile software programs, non-volatile computer-executable programs and modules stored in the memory, and thereby the methods for adjusting image quality of video in the aforementioned embodiments are achievable.

The memory can include a program storage area and a data storage area, wherein the program storage area can store an operating system and at least one application program required for a function; the data storage area can store data created according to the usage of the device for adjusting image quality of video. Furthermore, the memory can include a high speed random-access memory, and further include a non-volatile memory such as at least one disk storage member, at least one flash memory member, and other non-volatile solid-state memory member. In some embodiments, the memory can have a remote connection with the processor, and such memory can be connected to the device for adjusting image quality of video by a network. The aforementioned network includes, but not limited to, internet, intranet, local area network, mobile communication network and combination thereof.

The input device can receive digital or character information, and generate a key signal input regarding a user setup of the device for adjusting image quality of video and a function control. The output device can include a displaying unit such as screen.

The one or more modules are stored in the memory. When the one or more modules are executed by one or more processor, the method for adjusting image quality of video is performed.

The technical solutions and the functional characteristics and connections of each module in the device are the same as in the embodiments of FIG. 1 to FIG. 6. Please refer to the aforementioned embodiments of FIG. 1 to FIG. 6 if necessary.

The electronic apparatus in the embodiments of the present application is presence in many forms, and the electronic apparatus includes, but not limited to:

(1) Mobile communication apparatus: characteristics of this type of device are having the mobile communication function, and providing the voice and the data communications as the main target. This type of terminals include: smart phones (e.g. iPhone), multimedia phones, feature phones, and low-end mobile phones, etc.
(2) Ultra-mobile personal computer apparatus: this type of apparatus belongs to the category of personal computers, there are computing and processing capabilities, generally includes mobile Internet characteristic. This type of terminals include: PDA, MID and UMPC equipment, etc., such as iPad.
(3) Portable entertainment apparatus: this type of apparatus can display and play multimedia contents. This type of apparatus includes: audio, video player (e.g. iPod), handheld game console, e-books, as well as smart toys and portable vehicle-mounted navigation apparatus.
(4) Server: an apparatus provide computing service, the composition of the server includes processor, hard drive, memory, system bus, etc, the structure of the server is similar to the conventional computer, but providing a highly reliable service is required, therefore, the requirements on the processing power, stability, reliability, security, scalability, manageability, etc. are higher.
(5) Other electronic apparatus having a data exchange function.

The embodiments of device described above are exemplary, wherein the units described as separate components could be or could not be physically separated from each other. The components used as units could be or could not be physical units. The components could be located in one place or could be spread over multiple network elements. According to the actual demand, part of modules or all modules can be selected to achieve the purpose of the embodiments of the present invention. Persons having ordinary skills in the art could realize and implement the embodiments of the present invention without providing creative efforts.

Through the above descriptions of embodiments, those skilled in the art can clearly realize each embodiment can be implemented using software plus essential common hardware platforms. Certainly each embodiment can be implemented using hardware. Based on the understanding, the above technical solutions or part of the technical solutions contributing to the prior art could be embodied in form of software products. The computing software products can be stored in a computer-readable storage medium such as ROM/RAM, disk, compact disc, etc. The computing software products include several instructions configured to make a computing device (a personal computer, a server, or internet device, etc) carry out the methods in each embodiments or part of methods in the embodiments.

Finally, it should be noted that: the above embodiments are just used for illustrating the technical solutions of the present application and not for limiting the present application. Even though the present application is illustrated clearly referring to the previous embodiments, persons having ordinary skills in the art should realize the technical solutions described in the aforementioned embodiments can be modified or part of technical features can be displaced equivalently. The modification or the displacement would not make corresponding essentials of the technical solutions out of spirit and scope of the technical solution of each embodiment of the present application.

What is claimed is:

1. A method for adjusting image quality of video, comprising:
acquiring a luminance histogram of a current video frame according to a grayscale image of the current video frame;
acquiring a number of a plurality of pixels on left half of the luminance histogram, a number of a plurality of pixels on right half of the luminance histogram and an trisected number of a plurality of pixels of the luminance histogram, according to the luminance histogram of a current video frame;
adjusting a luminance of the current video frame according to the number of the plurality of pixels on left half of the luminance histogram and the number of the plurality of pixels on right half of the luminance histogram; and
adjusting a contrast ratio of the current video frame according to the trisected number of the plurality of pixels of the luminance histogram.

2. The method according to claim 1, wherein the acquiring the number of the plurality of pixels on left half of the luminance histogram and the number of the plurality of pixels on right half of the luminance histogram comprises:
calculating the number of the plurality of pixels on left half of the luminance histogram and the number of the plurality of pixels on right half of the luminance histogram through a histogram function according to the luminance histogram of the current video frame;
wherein formulas for calculating the number of the plurality of pixels on left half of the luminance histogram and the number of the plurality of pixels on right half of the luminance histogram are:
$$\{ \begin{matrix}{S}_{l} = {\sum }_{i = 0}^{127} hist [ i ] \\ {S}_{r} = {\sum }_{i = 128}^{255} hist [ i ]\end{matrix} ;$$
wherein hist is the histogram function, i is a grayscale value of the luminance histogram, Sₗ represents the number of the plurality of pixels on left half of the luminance histogram, and Sᵣ represents the number of the plurality of pixels on right half of the luminance histogram.

3. The method according to claim 1, wherein the acquiring the trisected number of the plurality of pixels of the luminance histogram comprises:
calculating the trisected number of the plurality of pixels of the luminance histogram through a histogram function according to the luminance histogram of the current video frame, wherein formulas for calculating the trisected number of the plurality of pixels of the luminance histogram are:
$$\{ \begin{matrix}{C}_{l} = {\sum }_{i = 0}^{84} hist [ i ] \\ {C}_{m} = {\sum }_{i = 85}^{170} hist [ i ] \\ {C}_{r} = {\sum }_{i = 171}^{255} hist [ i ]\end{matrix}$$
wherein i is a grayscale value of the luminance histogram, and Cₗ, Cₘ and Cᵣ respectively represents the trisected number of the plurality of pixels of the luminance histogram

4. The method according to claim 1, wherein the adjusting the luminance of the current video frame according to the number of the plurality of pixels on left half of the luminance histogram and the number of the plurality of pixels on right half of the luminance histogram comprises:
calculating a luminance distribution ratio of the luminance histogram according to the number of the plurality of pixels on left half of the luminance histogram and the number of the plurality of pixels on right half of the luminance histogram, the luminance distribution ratio is labeled as Rᵢ, and an formula for calculating the luminance distribution ratio is:
$${R}_{i} = \frac{{S}_{l}}{{S}_{r}} ;$$
increasing the luminance of the current video frame by y=x^{0.5} if Ri is greater than a first threshold; and
decreasing the luminance of the current video frame by y=x² if Ri is less than a second threshold;
wherein x represents an input pixel value before adjusting the luminance of the current video frame, y represents an output pixel value after adjusting the luminance of the current video frame, the input pixel value is normalized to be in a range from 0 to 1, and the output pixel value is conversely normalized to be within an original range from 0 to 255 from the range from 0 to 1.

5. The method according to claim 1, wherein the adjusting the contrast ratio of the current video frame according to the trisected number of the plurality of pixels of the luminance histogram comprises:
adjusting the contrast ratio of the current video frame through an formula
$$y = 1 + \frac{2 ( x - 1 )}{1 + {( x - 1 )}^{2}}$$
if the trisected number of the plurality of pixels of the luminance histogram Cₗ, Cₘ and Cᵣ satisfies an formula Cₘ>Cₗ+Cᵣ;
wherein x represents an input pixel value before adjusting the contrast ratio of the current video frame, y represents an output pixel value after adjusting the contrast ratio of the current video frame, the input pixel value is normalized to be within a range from 0 to 2, and the output pixel value is conversely normalized to be within an original range from 0 to 255 from the range from 0 to 2.

6. A non-volatile computer storage medium storing computer-executable instructions, the computer-executable instructions are set as:
acquiring a luminance histogram of a current video frame according to a grayscale image of the current video frame;
acquiring a number of a plurality of pixels on left half of the luminance histogram, a number of a plurality of pixels on right half of the luminance histogram and an trisected number of a plurality of pixels of the luminance histogram, according to the luminance histogram of a current video frame;
adjusting a luminance of the current video frame according to the number of the plurality of pixels on left half of the luminance histogram and the number of the plurality of pixels on right half of the luminance histogram; and
adjusting a contrast ratio of the current video frame according to the trisected number of the plurality of pixels of the luminance histogram.

7. An electronic apparatus, comprising:
at least one processor; and
a memory communicatively connected to the at least one processor; wherein,
the memory stores an instructions processed by the at least one processor, the instruction is processed by the at least one processor so that the at least one processor can be configured to:
acquiring a luminance histogram of a current video frame according to a grayscale image of the current video frame;
acquiring a number of a plurality of pixels on left half of the luminance histogram, a number of a plurality of pixels on right half of the luminance histogram and an trisected number of a plurality of pixels of the luminance histogram, according to the luminance histogram of a current video frame;
adjusting a luminance of the current video frame according to the number of the plurality of pixels on left half of the luminance histogram and the number of the plurality of pixels on right half of the luminance histogram; and
adjusting a contrast ratio of the current video frame according to the trisected number of the plurality of pixels of the luminance histogram.

8. The non-volatile computer storage medium according to claim 6, wherein acquiring the number of the plurality of pixels on left half of the luminance histogram and the number of the plurality of pixels on right half of the luminance histogram comprises:
calculating the number of the plurality of pixels on left half of the luminance histogram and the number of the plurality of pixels on right half of the luminance histogram through a histogram function according to the luminance histogram of the current video frame;
wherein formulas for calculating the number of the plurality of pixels on left half of the luminance histogram and the number of the plurality of pixels on right half of the luminance histogram are:
$$\{ \begin{matrix}{S}_{l} = {\sum }_{i = 0}^{127} hist [ i ] \\ {S}_{r} = {\sum }_{i = 128}^{255} hist [ i ]\end{matrix} ;$$
wherein hist is the histogram function, i is a grayscale value of the luminance histogram, Sₗ represents the number of the plurality of pixels on left half of the luminance histogram, and Sᵣ represents the number of the plurality of pixels on right half of the luminance histogram.

9. The non-volatile computer storage medium according to claim 6, wherein the acquiring the trisected number of the plurality of pixels of the luminance histogram comprises:
calculating the trisected number of the plurality of pixels of the luminance histogram through a histogram function according to the luminance histogram of the current video frame, wherein formulas for calculating the trisected number of the plurality of pixels of the luminance histogram are:
$$\{ \begin{matrix}{C}_{l} = {\sum }_{i = 0}^{84} hist [ i ] \\ {C}_{m} = {\sum }_{i = 85}^{170} hist [ i ] \\ {C}_{r} = {\sum }_{i = 171}^{255} hist [ i ]\end{matrix}$$
wherein i is a grayscale value of the luminance histogram, and Cₗ, Cₘ and Cᵣ respectively represents the trisected number of the plurality of pixels of the luminance histogram.

10. The non-volatile computer storage medium according to claim 6, wherein the adjusting the luminance of the current video frame according to the number of the plurality of pixels on left half of the luminance histogram and the number of the plurality of pixels on right half of the luminance histogram comprises:
calculating a luminance distribution ratio of the luminance histogram according to the number of the plurality of pixels on left half of the luminance histogram and the number of the plurality of pixels on right half of the luminance histogram, the luminance distribution ratio is labeled as Rᵢ, and an formula for calculating the luminance distribution ratio is:
$${R}_{i} = \frac{{S}_{l}}{{S}_{r}} ;$$
increasing the luminance of the current video frame by y=x^{0.5} if Ri is greater than a first threshold; and
decreasing the luminance of the current video frame by y=x² if Ri is less than a second threshold;
wherein x represents an input pixel value before adjusting the luminance of the current video frame, y represents an output pixel value after adjusting the luminance of the current video frame, the input pixel value is normalized to be in a range from 0 to 1, and the output pixel value is conversely normalized to be within an original range from 0 to 255 from the range from 0 to 1.

11. The non-volatile computer storage medium according to claim 6, wherein the adjusting the contrast ratio of the current video frame according to the trisected number of the plurality of pixels of the luminance histogram comprises:
adjusting the contrast ratio of the current video frame through an formula
$$y = 1 + \frac{2 ( x - 1 )}{1 + {( x - 1 )}^{2}}$$
if the trisected number of the plurality of pixels of the luminance histogram Cₗ, Cₘ and Cᵣ satisfies an formula Cₘ>Cₗ+Cᵣ;
wherein x represents an input pixel value before adjusting the contrast ratio of the current video frame, y represents an output pixel value after adjusting the contrast ratio of the current video frame, the input pixel value is normalized to be within a range from 0 to 2, and the output pixel value is conversely normalized to be within an original range from 0 to 255 from the range from 0 to 2.

12. The electronic apparatus according to claim 7, wherein acquiring the number of the plurality of pixels on left half of the luminance histogram and the number of the plurality of pixels on right half of the luminance histogram comprises:
calculating the number of the plurality of pixels on left half of the luminance histogram and the number of the plurality of pixels on right half of the luminance histogram through a histogram function according to the luminance histogram of the current video frame;
wherein formulas for calculating the number of the plurality of pixels on left half of the luminance histogram and the number of the plurality of pixels on right half of the luminance histogram are:
$$\{ \begin{matrix}{S}_{l} = {\sum }_{i = 0}^{127} hist [ i ] \\ {S}_{r} = {\sum }_{i = 128}^{255} hist [ i ]\end{matrix} ;$$
wherein hist is the histogram function, i is a grayscale value of the luminance histogram, Sₗ represents the number of the plurality of pixels on left half of the luminance histogram, and Sᵣ represents the number of the plurality of pixels on right half of the luminance histogram.

13. The electronic apparatus according to claim 7, wherein acquiring the trisected number of the plurality of pixels of the luminance histogram comprises:
calculating the trisected number of the plurality of pixels of the luminance histogram through a histogram function according to the luminance histogram of the current video frame, wherein formulas for calculating the trisected number of the plurality of pixels of the luminance histogram are:
$$\{ \begin{matrix}{C}_{l} = {\sum }_{i = 0}^{84} hist [ i ] \\ {C}_{m} = {\sum }_{i = 85}^{170} hist [ i ] \\ {C}_{r} = {\sum }_{i = 171}^{255} hist [ i ]\end{matrix}$$
wherein i is a grayscale value of the luminance histogram, and Cₗ, Cₘ and Cᵣ respectively represents the trisected number of the plurality of pixels of the luminance histogram.

14. The electronic apparatus according to claim 7, wherein the adjusting the luminance of the current video frame according to the number of the plurality of pixels on left half of the luminance histogram and the number of the plurality of pixels on right half of the luminance histogram comprises:
calculating a luminance distribution ratio of the luminance histogram according to the number of the plurality of pixels on left half of the luminance histogram and the number of the plurality of pixels on right half of the luminance histogram, the luminance distribution ratio is labeled as Rᵢ, and an formula for calculating the luminance distribution ratio is:
$${R}_{i} = \frac{{S}_{l}}{{S}_{r}} ;$$
increasing the luminance of the current video frame by y=x^{0.5} if Ri is greater than a first threshold; and
decreasing the luminance of the current video frame by y=x² if Ri is less than a second threshold;
wherein x represents an input pixel value before adjusting the luminance of the current video frame, y represents an output pixel value after adjusting the luminance of the current video frame, the input pixel value is normalized to be in a range from 0 to 1, and the output pixel value is conversely normalized to be within an original range from 0 to 255 from the range from 0 to 1.

15. The electronic apparatus according to claim 7, wherein the adjusting the contrast ratio of the current video frame according to the trisected number of the plurality of pixels of the luminance histogram comprises:
adjusting the contrast ratio of the current video frame through an formula
$$y = 1 + \frac{2 ( x - 1 )}{1 + {( x - 1 )}^{2}}$$
if the trisected number of the plurality of pixels of the luminance histogram Cₗ, Cₘ and Cᵣ satisfies an formula Cₘ>Cₗ+Cᵣ.
